(19) United States
(12) Patent Application Publication
(10) Pub. No.: US 2011/0185866 A1
(43) Pub. Date: Aug. 4, 2011

(54) CEILING GRID BEAM CUTTING APPARATUS

(76) Inventors: Josef Mirer, Riverdale, NY (US); Christian Cerna, Selden, NY (US)

(21) Appl. No.: 13/059,382

(22) PCT Filed: Jul. 24, 2009
(86) PCT No.: PCT/US2009/051712

§ 371 Date: Feb. 16, 2011

Related U.S. Application Data
(60) Provisional application No. 61/083,357, filed on Jul. 24, 2008.

(51) Int. Cl. E04B 9/06; B26D 3/00; B23D 45/02

(52) U.S. Cl. 83/13; 52/749.1

(57) ABSTRACT

A ceiling grid beam cutting apparatus is provided. The ceiling grid beam cutting apparatus includes a base plate and a cutting instrument combined with two clamps and a guide plate. The clamps and guide plate secure the ceiling grid beam to the base plate. The clamps are positioned at opposite 45 degree angles from the cutting instrument. The guide plate is positioned to hold the ceiling grid beam securely on its side to allow for precise off-center cuts of the ceiling grid beam to form a connection tab.

### FIELD OF THE INVENTION

The present invention relates to a portable construction tool and, more particularly, to a clamp and cutting tool for cutting ceiling grids at a work site.

### BACKGROUND

Installing ceiling grids is a common task for contractors. The grids are necessary to support certain ceiling structures and must be cut to an exact size before installation. In ideal situations, the grids are cut at a factory or large processing center and then shipped to the installation site. But in certain circumstances, the grids need to be resized and this fact is only realized upon receipt of the grids at the installation site or in the process of actual installation.

In such circumstances, the grids must be shipped back to the factory for resizing and then re-shipped to the work site. This adds significant time and expense to the installation process.

### SUMMARY

An objective of the present invention is to provide a device for cutting ceiling grid beams, or other similar objects, in the field. By cutting the ceiling grid beams in the field, the user avoids shipping the ceiling grid beams back to the factory.

In order to achieve this and other objectives, the present invention includes two clamps, a guide plate and a cutting device which are all connected to a base plate. The clamps and guide plate are used to grip and hold a ceiling grid beam and the cutting device is used to cut through the grid beam at the desired points.

The cutting device is preferably a circular saw. The base plate, clamps and guide plate can be provided without the cutting device.

### DESCRIPTION OF DRAWINGS

FIG. 1 is a perspective view of the ceiling grid cutting apparatus of the present invention, with a ceiling grid beam positioned between a support and a clamp;

FIG. 2 is a top plan view of the ceiling grid cutter apparatus of the present invention, with a ceiling grid beam positioned between a support and a clamp;

FIG. 3 is a top plan view of the ceiling grid cutter apparatus of the present invention, with a ceiling grid beam positioned on the rotating guide plate; and

FIG. 4 is a perspective view of a cut ceiling grid beam.

### DETAILED DESCRIPTION

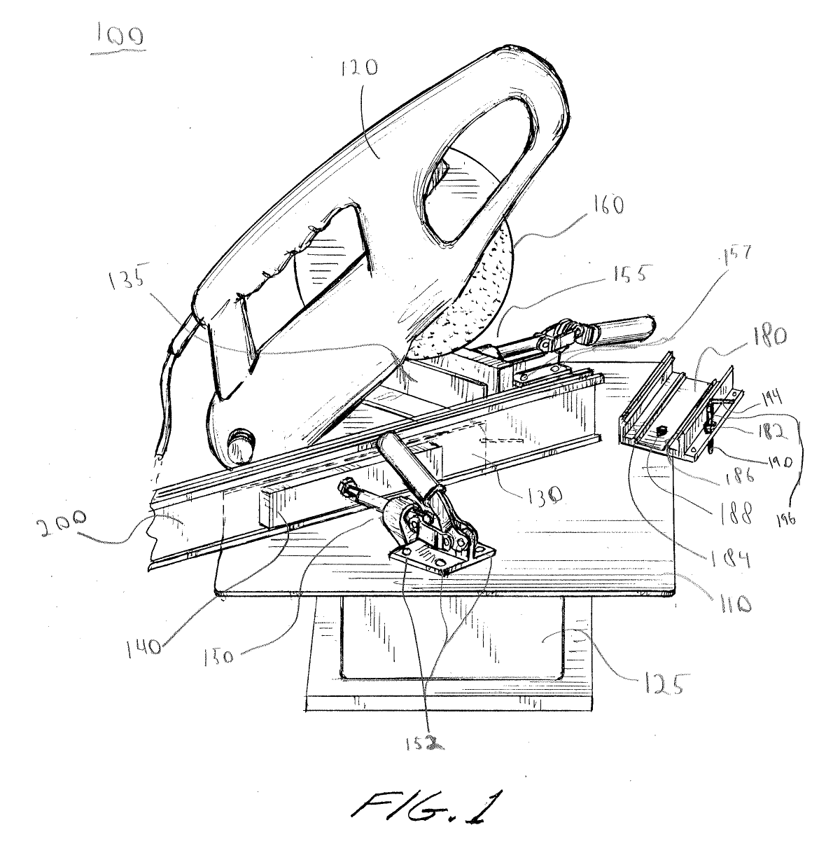

As seen in FIG. 1, grid cutter assembly 100 of the present invention includes circular saw 120, base plate 110, two supports 130 and 135, two clamps 150 and 155 and rotating guide plate 180.

Circular saw 120 is preferably a conventional circular saw with base 125 and saw blade 160, but may also be a basic hack saw. Various sized version of circular saw 120 are consistent with this invention, though a smaller version is used herein for illustrative purposes.

Base plate 110 is preferably an aluminum plate of thin rectangular shape. Aluminum is preferred because it is inexpensive and light weight, but any strong flat surface is usable. Base plate 110 has attached to it left support 130, right support 135, left clamp 150, right clamp 155 and rotating guide plate 180. Base plate 110 is removably attached to base 125, preferably by removable screws. Left support 130 and left support 135 are attached to base plate 110, preferably by removable screws or glue. Left clamp 150 is attached to base plate 110 by screws 152 and right clamp 155 is attached to base plate 110 by screws 157. Rotating guide plate 180 is attached to base plate 110 by loose fitted screw 188. And lastly, base plate 110 includes blade slit 170. Blade slit 170 allows saw blade 160 to pass through the plane of base plate 110 without damaging base plate 110.

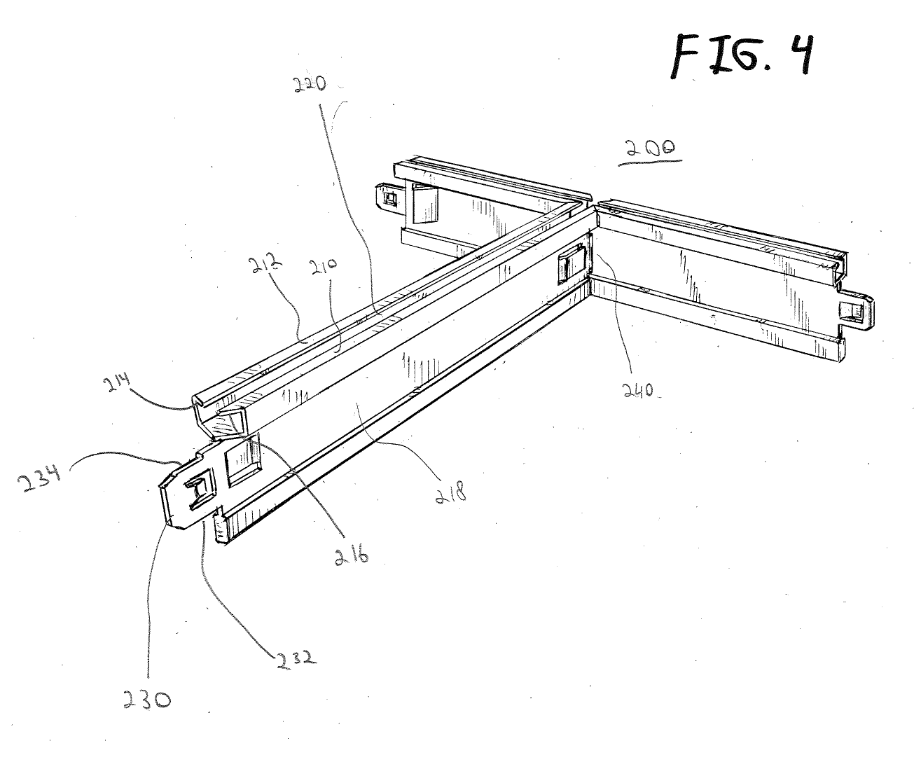

FIG. 4 illustrates ceiling grid beam 200 after it has been cut. One end of ceiling grid beam 200 is fixed to beam center 240, while the opposite end is exposed. Beam 200 includes right top wall 210, left wall top wall 212, center slit 220, left angled joint 214, right angled joint 216, connection tab 230, connection tab bottom 232, and connection tab top 234.

The present invention operates to shorten a ceiling grid beam in the form of ceiling grid beam 200. In this process it is important to maintain the edge shape of ceiling grid beam 200, specifically the 45 degree angle of left angled joint 214, the 45 degree angle of right angled joint 216 and connection tab 230.

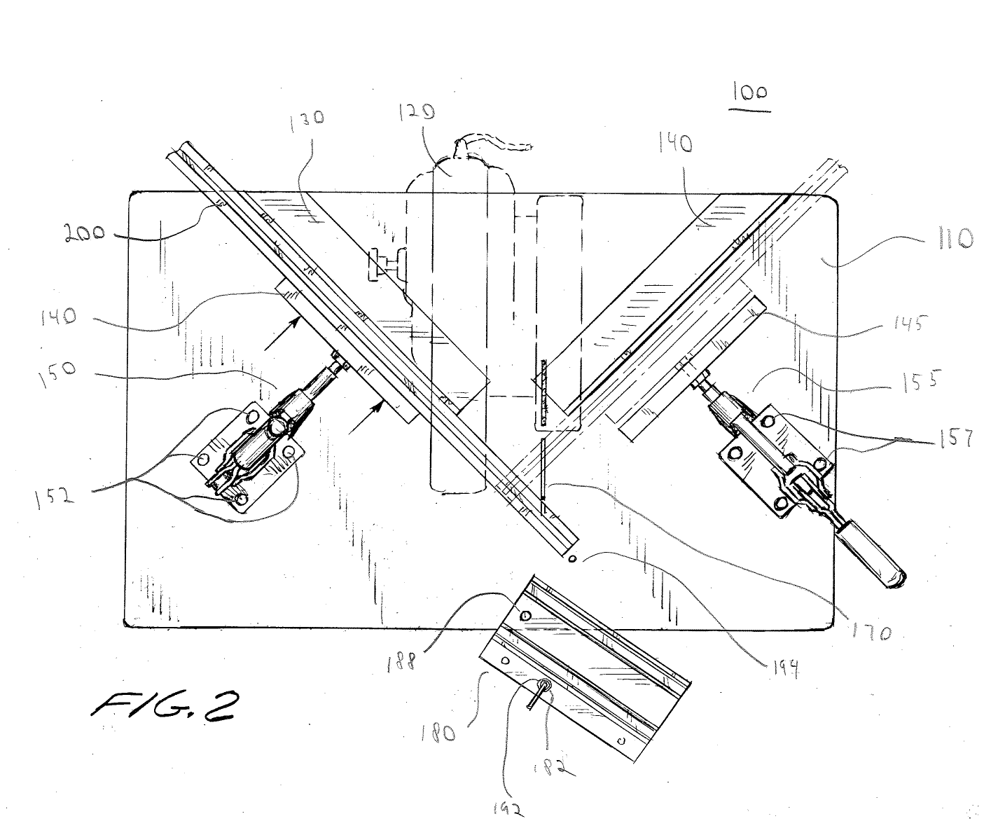

As illustrated in FIG. 2, ceiling grid beam 200 is placed between left support 130, which has a flat solid side, and left clamping bar 140. Clamp 150 is engaged to apply a force on left clamping bar 140 in the direction of left support 130, thus holding ceiling grid beam 200 in a fixed position. Circular saw 120 is turned on and saw blade 160 rotates at a cutting speed. Saw blade 160 is lowered and cuts through left top wall 212 to form right angled joint 216, which is at a 45 degree angle from the length of ceiling grid beam 200. Ceiling grid beam body 218 is cut to form connection tab 230 while ceiling grid beam 200 is held by rotating guide plate 180, as discussed below.

As shown in FIG. 4, ceiling grid beam 200 has left angled joint 214 and right angled joint 216. Right angled joint 216 is formed by securing ceiling grid beam 200 with left clamp 150. Left angled joint 214 is formed in the same manner using right support 130 and right clamp 155.

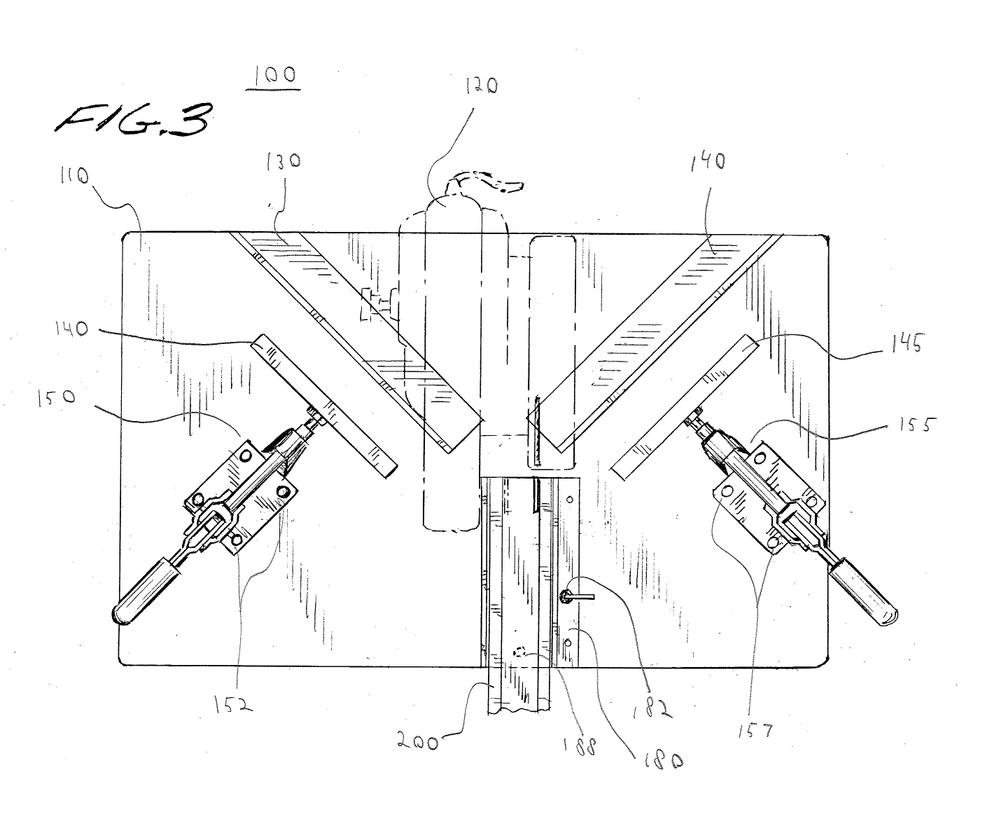

Ceiling grid beam 200 includes connection tab 230. Connection tab 230 fits into beam center 240 when joining together two of ceiling grid beam 200. Connection tab 230 is formed by aligning rotating guide plate 180 to the closed position shown in FIG. 3. Rotating guide plate 180 is secured to base plate 110 by loose fitted screw 188. Rotating guide plate 180 includes lock 182, left guide rail 184 and right guide rail 186. Lock 182 further includes peg 190 and spring 196. In the closed position of FIG. 3, peg 190 fits through hole 192 in rotating guide plate 180 and hole 194 in base plate 110. Peg 190 is forced downward by an internal spring and includes peg handle 194 for lifting peg 190 and removing it from holes 192 and 194.

FIG. 3 illustrates the use of grid cutter assembly 100 to form connection tab 230. Ceiling grid beam 200 is tilted, such that channel 220 fits over left guide rail 184. The fit between channel 220 and left guide rail 184 holds ceiling grid beam 200 in place. Circular saw 120 and saw blade 160 are lowered to cut through ceiling grid beam body 218 to form connection tab top 234. Ceiling grid beam 200 is then flipped 180 degrees and channel 220 is fit over right guide rail 186. Saw blade 160 is lowered and cuts through ceiling grid beam body 218 to form connection tab bottom 232. Connection tab 230 is formed because saw blade 160 is aligned off the center of rotating guide plate 180. The width of connection tab 230 will be approximately twice the distance in which saw blade 160 is away from the center of rotating guide plate 180. The remaining extremities of ceiling grid beam body 218 can be removed by any less precise means.

Although the invention has been described in terms of particular embodiments, the embodiments are merely illustrative of an application of the principles of the invention. Numerous modifications may be made and other arrangements may be devised without departing from the spirit and scope of the invention.

We claim:

1. A base plate apparatus for removably connecting with a circular saw and for securing a ceiling grid beam, the base plate apparatus comprising:
a base plate adapted to receive a cutting instrument, the cutting instrument having a blade;
a first support beam fixed to the base plate, the first support beam positioned at a 45 degree angle from the saw blade; and
a first clamp, fixed to the base plate and selectively applying force in the direction of the first support beam.

2. The base plate apparatus of claim 1, further comprising:
a second support beam fixed to the base plate and positioned at a 45 degree angle from the blade and at a 90 degree angle from the first support beam;
a second clamp fixed to the base plate and selectively applying force in the direction of the second support beam.

3. The base plate apparatus of claim 1, further comprising:
a rotating guide plate rotateably attached to the base plate;
a left guide rail and a right guide rail, both positioned to be inserted into a top channel of a ceiling grid beam;
wherein the rotating guide plate has a position which aligns with the blade.

4. The base plate apparatus of claim 3, further comprising:
a lock selectively holding the rotating guide plate in the position which aligns with the blade.

5. The base plate apparatus of claim 3, further wherein:
the lock comprises:
a hole in the base plate;
a hole in the rotating guide plate, aligned with the hole in the base plate;
a peg for selective engaging the hole in the base plate and the hole in the rotating guide plate;
a peg handle attached to the peg, wherein:
the peg is forced downward by a spring force and can be lifted against the spring force by the peg handle.

6. A method of cutting a ceiling grid beam at a worksite with a cutting instrument, the ceiling grid beam having a top and a body, the method comprising:
securing the ceiling grid beam between a support and a clamp, the ceiling grid beam positioned approximately 45 degrees from a cutting instrument;
cutting through the top at approximately a 45 degree angle relative to the length of the ceiling grid beam;
aligning a guide plate with the cutting instrument;
securing the ceiling grid beam to the guide plate; and
cutting through the body at two points.
